(19) United States
(12) Patent Application Publication
(10) Pub. No.: US 2016/0112784 A1
(43) Pub. Date: Apr. 21, 2016

(54) SOUND VIBRATION EXCITATION ASSEMBLY FOR DISCRETE AREA SOUND-ABSORBING CEILING SURFACES, AND SOUND SYSTEM INCLUDING SUCH VIBRATION EXCITATION ASSEMBLY

(71) Applicant: Cambridge Sound Management, Inc., Waltham, MA (US)

(72) Inventors: John C. Heine, Weston, MA (US); Gordon V. Cook, Acton, MA (US); Thomas R. Horrall, Harvard, MA (US)

(21) Appl. No.: 14/884,958

(22) Filed: Oct. 16, 2015

Related U.S. Application Data
(60) Provisional application No. 62/065,492, filed on Oct. 17, 2014.

(51) Int. Cl. H04R 1/02; E04B 9/00; E04B 1/84; E04B 1/99; E04B 1/82; H04R 3/08; E04F 13/08

(52) U.S. Cl. CPC H04R 1/025; H04R 1/021; H04R 3/08; E04B 9/001; E04F 13/0867; E04B 1/99; E04B 1/8209; E04B 1/84; H04R 2201/021; H04R 2420/09

(57) ABSTRACT

A sound vibration excitation assembly, for producing direct field sound masking, paging and/or music, comprises a ceiling coupler configured to be coupled to a discrete area sound-absorbing ceiling surface comprising mineral fiber or fiberglass, and a vibration exciter that is both configured to be electrically coupled to one or more sources of an electrical sound signal and is coupled to the ceiling coupler to produce vibrations in the ceiling coupler in response to the electrical sound signal. Related sound systems and methods are provided.

### RELATED APPLICATION

This application claims the benefit of U.S. Provisional Application No. 62/065,492, filed on Oct. 17, 2014, the entire teachings of which application are incorporated herein by reference.

### BACKGROUND OF THE INVENTION

This invention relates to sound systems and, in particular, to sound masking systems for offices, e.g., open plan offices.

Freedom from distraction is an important consideration for workers' satisfaction with their office environment, and, in order to reduce the intelligibility of unwanted speech overheard in various office configurations, sound masking systems have been used. However, there is an ongoing need to improve the ease of installation, aesthetic appearance, power requirements, cost, effectiveness and/or other characteristics of sound masking systems.

### SUMMARY OF THE INVENTION

In accordance with an embodiment of the invention, there is provided a sound vibration excitation assembly for producing direct field sound masking, paging and/or music. The assembly comprises a ceiling coupler configured to be coupled to a single contact area on a discrete area sound-absorbing ceiling surface, such as an acoustical ceiling tile or cloud, comprising, e.g, mineral fiber or fiberglass, and a vibration exciter that is configured to be electrically coupled to one or more sources of an electrical sound signal and is coupled to the ceiling coupler to produce vibrations in the ceiling coupler in response to the electrical sound signal.

In further, related embodiments, the electrical sound signal may comprise a sound masking signal and/or at least one of a music signal and a paging signal. The ceiling coupler may comprise an attachment plate. The attachment plate may comprise a bottom surface configured to conform to and to be attached face to face to a surface of the discrete area sound absorbing ceiling surface. The bottom surface of the attachment plate may be, e.g., substantially flat, concave or convex, or undulating. The sound vibration excitation assembly may further comprise an adhesive layer on the bottom surface of the attachment plate, and a removable backing paper overlaying a bottom surface of the adhesive layer. In projection on to a flat surface, the attachment plate may comprise a continuously curved plate or a polygonal plate, such as a triangular plate. In another embodiment, the ceiling coupler may comprise a recess attachment piece configured to be positioned in a recess in a top surface of the discrete area sound absorbing ceiling surface. The recess attachment piece may comprise at least one spring-loaded fitting configured to penetrate the discrete area sound absorbing ceiling surface. In another embodiment, the ceiling coupler may comprise an attachment piece configured to be embedded inside the discrete area sound absorbing ceiling surface. The ceiling coupler may comprise a metal, such as steel or aluminum, and/or a plastic, such as at least one of poly(methyl methacrylate) and polycarbonate. The ceiling coupler may, but is not required to, comprise a substantially larger minimum dimension than a maximum dimension of the vibration exciter. The vibration exciter may comprise a voice coil, a piezoelectric element (such as a piezoelectric bender bar) or a single-ended electrostatic element. The vibration exciter may be mounted directly to the ceiling coupler.

In further, related embodiments, the discrete area sound-absorbing ceiling surface may comprise a mineral fiber ceiling tile. The sound vibration excitation assembly may further comprise a quick connect/disconnect jack electrically coupled to the vibration exciter. The quick connect/disconnect jack may correspond to a TIA/EIA-IS-968-A Registered Jack 45 (RJ-45) connector. The vibration exciter may be coupled to the ceiling coupler to produce vibrations in the discrete area sound-absorbing ceiling surface to thereby emit an acoustic sound signal in response to the electrical sound signal. When the electrical sound signal is a sound masking signal capable of causing the vibration excitation assembly to produce vibrations in the discrete area sound-absorbing ceiling surface, an acoustic sound masking signal is emitted, where the acoustic sound masking signal has a corresponding sound masking spectrum suitable for sound masking as is well known by those of skill in the art. The low end frequencies preferably comprise at least one of 50 Hz, 80 Hz and 100 Hz, most preferably 80 Hz. The high end frequencies are preferably less than 8 kHz and more preferably about 5300 Hz or less. The assembly may further comprise the one or more sources of the electrical sound signal attached to the ceiling coupler and electrically coupled to the vibration exciter. The assembly may further comprise an input network electrically coupled to the vibration exciter. The vibration exciter may be further electrically coupled to receive a Direct Current (DC) electrical current in addition to the electrical sound signal. The vibration exciter may, preferably, comprise a voice coil of a rating less than or equal to a 5 pound force.

The sound vibration excitation assembly may further comprise a cone loudspeaker assembly and a crossover circuit electrically coupled to the cone loudspeaker assembly and to a vibration exciter, where the crossover circuit is configured: (i) to operatively couple the one or more sources of the electrical sound signal to the vibration exciter to produce output of an acoustic sound signal from the discrete area sound-absorbing ceiling surface in a range of frequencies lower than a threshold frequency, and (ii) to operatively couple the one or more sources of the electrical sound signal to the cone loudspeaker assembly to produce output of the acoustic sound signal from the cone loudspeaker assembly in a range of frequencies higher than the threshold frequency.

In another embodiment according to the invention, there is provided a sound system, the system comprising: a discrete area sound-absorbing ceiling surface comprising mineral fiber or fiberglass; and any of the sound vibration excitation assemblies taught herein, the ceiling coupler being coupled to the single contact area on the discrete area sound-absorbing ceiling surface; wherein the vibration exciter of the sound assembly is coupled to the ceiling coupler to produce vibrations in the ceiling coupler in response to an electrical sound signal.

In further, related embodiments, the discrete area sound-absorbing ceiling surface may comprise a mixture comprising: mineral fibers, perlite, cellulosic fibers and a binder. The discrete area sound-absorbing ceiling surface may comprise a substantially uniform density mineral fiber core. The system may further comprise at least a top skin and a bottom skin of the discrete area sound-absorbing ceiling surface. The discrete area sound-absorbing ceiling surface may comprise a synthetic mineral wool, recycled paper and/or cloth. The discrete area sound-absorbing ceiling surface may be sized to fit within a suspended ceiling grid of multiple such discrete area sound-absorbing ceiling surfaces. The suspended ceiling grid may comprise a size of at least one of: one foot by one foot, two feet by two feet, and two feet by four feet. The discrete area sound-absorbing ceiling surface may be configured in at least one of: an arch shape, at least a portion of a cloud array of mineral fiber or fiberglass surfaces, a polygonal shape, an oval shape, and a circle shape. The ceiling coupler may be coupled to an upper surface of the discrete area sound-absorbing ceiling surface, wherein the discrete area sound-absorbing ceiling surface comprises no sound components protruding through or below its bottom surface. The discrete area sound-absorbing ceiling surface may comprise a pre-existing discrete area sound-absorbing ceiling surface in an area of a building comprising, e.g., a sound masking zone below the discrete area sound-absorbing ceiling surface, the pre-existing discrete area sound-absorbing ceiling surface having been otherwise unmodified for sound masking other than by coupling of the sound assembly to the surface of the discrete area sound-absorbing ceiling surface. The sound system may further comprise a cone loudspeaker assembly coupled to the discrete area sound-absorbing ceiling surface.

In another embodiment according to the invention, there is provided a method of performing sound masking. The method comprises supplying an electrical sound masking signal to a sound masking assembly, such as any of the sound masking assemblies taught herein, the sound masking assembly being coupled to a discrete area sound-absorbing ceiling surface, such as any such surfaces taught herein, to thereby cause the sound masking assembly to produce vibrations in the discrete area sound-absorbing ceiling surface in response to the electrical sound masking signal, and thereby emitting an acoustic sound masking signal.

In another embodiment according to the invention, there is provided a method of installing a sound masking system. The method comprises, prior to mounting the sound masking system to a discrete area sound-absorbing ceiling surface, electrically coupling one or more sources of an electrical sound masking signal to any of the sound assemblies taught herein. The method further comprises subsequently attaching the ceiling coupler of the sound assembly to an upper surface of the discrete area sound-absorbing ceiling surface to mount the sound masking system above the discrete area sound-absorbing ceiling surface. The sound masking system can then be operated without ever uncoupling the one or more sources of the electrical sound masking signal from the sound assembly. The method may further comprise installing in a similar fashion any of the sound systems taught herein.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a schematic side view diagram of a sound assembly in accordance with an embodiment of the invention.

FIG. 1B is a schematic top view diagram of a sound assembly in accordance with an embodiment of the invention.

FIG. 2A is a schematic side view diagram of a sound system including the sound assembly of FIGS. 1A and 1B, and a discrete area sound-absorbing ceiling surface, in accordance with an embodiment of the invention.

FIG. 2B is a schematic top view diagram of a discrete area sound-absorbing ceiling surface with single contact area, in accordance with an embodiment of the invention.

FIG. 3 is a schematic side view diagram of a sound system including a sound assembly with a recess ceiling coupler, in accordance with an embodiment of the invention.

FIG. 4 is a schematic side view diagram of a sound system including a sound assembly with an ceiling coupler embedded in a discrete area sound-absorbing ceiling surface, in accordance with an embodiment of the invention.

FIG. 5 is a schematic diagram of a sound system in accordance with an embodiment of the invention, in which a crossover circuit is used to employ a discrete area sound-absorbing ceiling surface in conjunction with a cone loudspeaker assembly.

FIG. 6 is a schematic diagram of a voice coil that may be used as a vibration exciter in accordance with an embodiment of the invention.

### DETAILED DESCRIPTION OF THE INVENTION

A description of example embodiments of the invention follows.

In accordance with an embodiment of the invention, there is provided a sound vibration excitation assembly that can be installed on a surface of a discrete area sound-absorbing ceiling surface, for example an ordinary, commercially sold mineral fiber ceiling tile, either pre- or post-installation. The sound assembly permits the discrete area sound-absorbing ceiling surface to be used, for example, to produce a sound masking signal for performing sound masking in a predetermined area below the sound-absorbing ceiling surface, and may also be used for emitting other sounds into the area, such as music and paging sound. The sound assembly provides an aesthetically unobtrusive sound system, and may permit more convenient installation of the sound system compared to other such systems. Further advantages of embodiments according to the invention are discussed below.

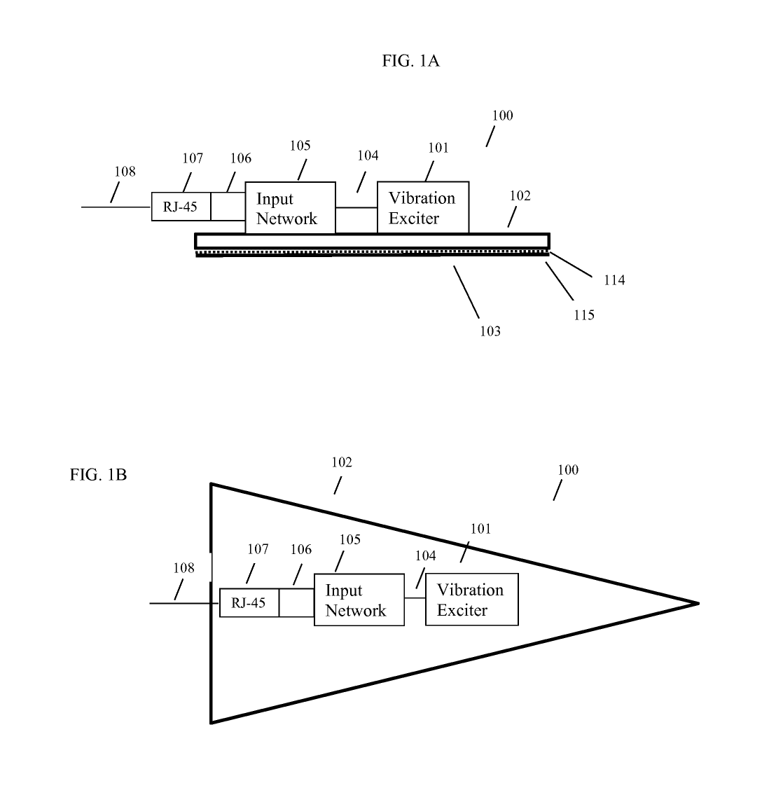

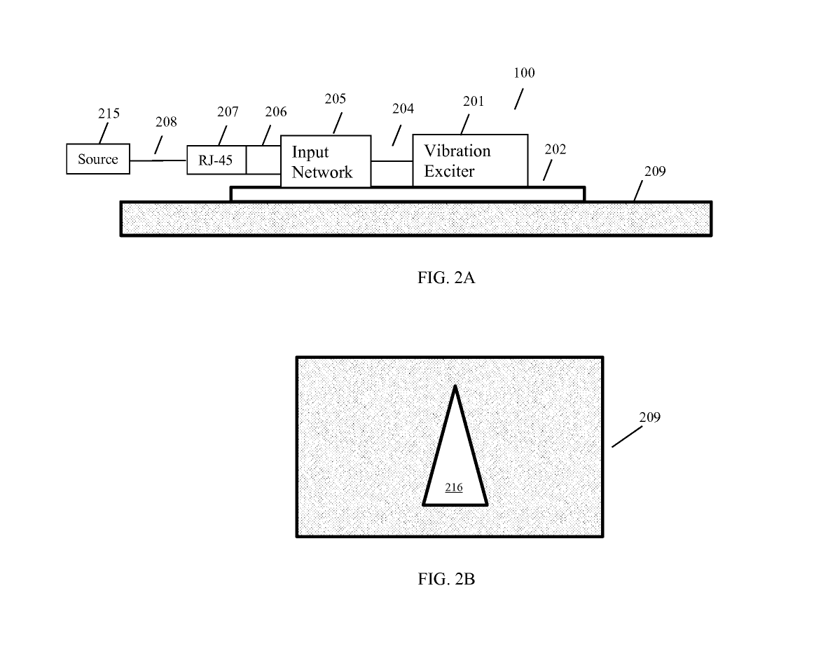

FIG. 1A is a schematic side view diagram of a sound vibration excitation assembly 100 in accordance with an embodiment of the invention. The sound assembly includes a vibration exciter 101 that is coupled, e.g., adhesively or mechanically, to a ceiling coupler, which in this embodiment is an attachment plate 102 that has a substantially flat bottom surface 103, which is configured to be adhesively bonded face to face to a surface of a discrete area sound-absorbing ceiling surface, such as an ordinary, commercially sold mineral fiber ceiling tile (see 209 in FIG. 2A). Alternatively, the attachment plate 102 (or other ceiling coupler) may be mechanically fastened to the discrete area sound-absorbing ceiling surface, for example using screws or other mechanical fasteners. As shown in FIG. 1A, the vibration exciter 101 is electrically coupled to one or more sources of an electrical sound signal (see 215 in FIG. 2A), for example via electrical connection 104, input network 105, quick connect/disconnect jack 106, RJ-45 connector 107 and cable 108 (such as a CAT 3 or CAT 5 cable), which leads to the one or more sources of the electrical sound signal. The vibration exciter 101 is coupled to the ceiling coupler, such as attachment plate 102 (for example, adhesively or mechanically) to produce vibrations in the attachment plate in response to the electrical sound signal. The vibration exciter 101 may, for example, be positioned so that it is directly in contact with the ceiling coupler, such as attachment plate 102, for example by being directly adhered to the attachment plate 102; or may be mechanically coupled to the ceiling coupler using an intermediate mechanical structure such as a small cylinder. The attachment plate 102 may extend to fully separate the vibration exciter 101 from the surface of an underlying mineral fiber ceiling tile 209 (see FIG. 2A). As shown in FIG. 2A, attachment plate 102 is adhesively bonded, in operation, to the discrete area sound-absorbing ceiling surface 209 so that the sound assembly attaches to the discrete area sound-absorbing ceiling surface 209 solely by adhesive bonding and without any intrusion of a mechanical structure into the mineral fiber ceiling tile 209, such as by a screw. The discrete area sound-absorbing ceiling surface 209 is vibrated in response to operation of the vibration exciter 101 and consequent vibration of the attachment plate 102, so that the discrete area sound-absorbing ceiling surface 209 outputs an acoustic sound signal corresponding to the electrical sound signal.

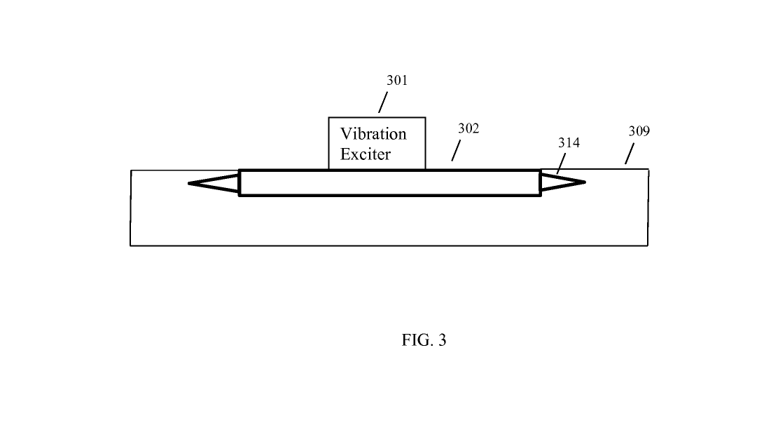

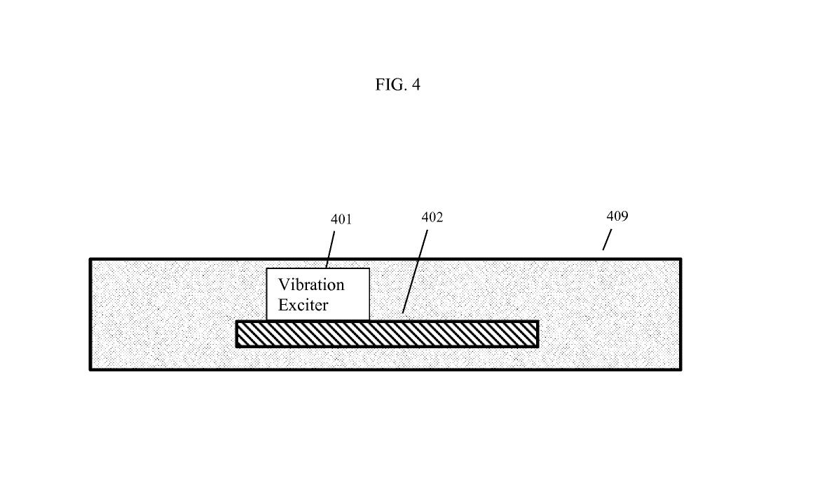

In accordance with an embodiment of the invention, a ceiling coupler, such as attachment plate 102, may be configured to be coupled to a single contact area 216 on the discrete area sound-absorbing ceiling surface 209, as shown in FIG. 2B. As used herein, a “single contact area” means one and only one closed and bounded region of the discrete area sound-absorbing ceiling surface 209, substantially the entirety of which region contacts the ceiling coupler. For example, the triangular region 216 of surface 209 (see FIG. 2B) to which the attachment plate 202 of FIG. 2A attaches, is an example of such a “single contact area” 216 of the surface 209. It will be appreciated that, for an attachment piece that is recessed or embedded, as taught relative to FIGS. 3 and 4 herein, the “single contact area” means the entirety of the closed and bounded surface that contacts the attachment piece, such as coupler 302 of FIG. 3 or 402 of FIG. 4 (see below). Further, it will be appreciated that ceiling couplers that are coupled to two or more contact regions in close proximity, such as preferably less than about two inches, more preferably less than about one inch, and most preferably less than about one half inch, may nevertheless function equivalently to such a single contact area, and are therefore included within the term.

FIG. 1B is a schematic top view diagram of a sound assembly 100 in accordance with an embodiment of the invention, showing the components of FIG. 1A as viewed from above. The attachment plate 102 may be in the form of a polygon when viewed from above, such as a triangle. Other shapes may be used in order to optimize acoustic sound performance. For example, the attachment plate may be continuously curved. The attachment plate may be symmetric or asymmetric. The attachment plate 102 may, for example, be of a substantially planar shape, of about ⅛ inch thickness or less, or about ¼ inch or less thickness. The ceiling coupler, such as the attachment plate 102, may comprise a substantially larger minimum dimension than a maximum dimension of the vibration exciter 101, or may be the same size, such as: the same size as, or at least four times, or at least six times, or at least eight times, or at least ten times greater than the diameter of the vibration exciter 101, or between about four times and about ten times greater. The ceiling coupler, such as the attachment plate, may be formed of a metal (such as aluminum or steel) and/or of a plastic, such as, for example, poly(methyl methacrylate) or polycarbonate. There may be, for example, an adhesive layer 114 on the substantially flat bottom surface 103 (see FIG. 1A) of the attachment plate 102, which may be covered with a removable backing paper 115 overlaying a bottom surface of the adhesive layer, so that the backing paper can be removed to permit the bottom surface 103 (see FIG. 1A) to be adhesively bonded face to face to the top surface of the discrete area sound-absorbing ceiling surface 209 (see FIG. 2A) upon installation of the sound assembly.

In the embodiments of FIGS. 1A and 1B, it can be seen that the sound assembly may include a quick connect/disconnect jack 106 for ease of installation. For example, the jack 106 may correspond to a TIA/EIA-IS-968-A Registered Jack (RJ-45) connector 107. During installation, the connectors 106/107 may be pre-connected, prior to installation of the sound assembly on the discrete area sound-absorbing ceiling surface 209 (see FIG. 2A). Because the sound assembly 102 may be attached without the need for any components to protrude through the discrete area sound-absorbing ceiling surface 209, the pre-connected connectors 106/107 may then be left connected without having to be disconnected prior to installation of the sound system. The sound system may, therefore, be installed and then adjusted with the connectors 106/107 already pre-connected.

FIG. 2A is a schematic side view diagram of a sound system including a sound assembly 100 and a discrete area sound-absorbing ceiling surface 209, such as a mineral fiber ceiling tile, in accordance with an embodiment of the invention. Components 201-208 correspond to components 101-108 of FIGS. 1A-1B. The one or more sources 215 of the electrical sound signal is shown connected to cable 208. It can be seen in this installation that the attachment plate 102 is adhesively bonded face to face to the top surface of the discrete area sound-absorbing ceiling surface 209. In accordance with an embodiment of the invention, the discrete area sound-absorbing ceiling surface 209 may be an ordinary, commercially sold mineral fiber ceiling tile. The discrete area sound-absorbing ceiling surface 209 may, for example, include a synthetic mineral wool, such as a ceramic wool or stone wool; and may further include recycled paper and/or cloth. Further, the discrete area sound-absorbing ceiling surface may comprise a mixture comprising mineral fibers, perlite, cellulosic fibers and a binder; for example, a mixture of about 50 to 70 weight percent of mineral fibers, 15 to 35 weight percent of perlite, 1 to 10 weight percent of cellulosic fibers, and 4 to 15 weight percent of a binder, such as a starch, or any other mixture as taught in U.S. Pat. No. 5,071,511 of Pittman, the teachings of which patent are incorporated by reference in their entirety. It will be appreciated that other mineral fiber ceiling tiles may be used. In another example, the discrete area sound-absorbing ceiling surface 209 may include a central mineral fiber core, which may be of a substantially uniform density, allowing for the presence of small pin-holes that are sometimes manufactured in mineral fiber ceiling tiles. Above the central mineral fiber core may be a thin top skin on the surface nearest to the ceiling coupler, such as attachment plate 202, and below the mineral fiber core may be a thin bottom skin on the surface opposite the ceiling coupler, such as attachment plate 202. The mineral fiber core may, for example, comprise the mineral wool fibers and one or more fillers, light weight aggregates, colorants and/or binders. The top skin may, for example, include a back coating. The bottom skin may, for example, include a scrim (such as a non-woven facing attached to the mineral fiber core with a latex adhesive) and a face coating (such as a finish paint applied to the scrim). In addition to mineral fiber ceiling tiles, other types of discrete area sound-absorbing ceiling surface 209 may be used, such as fiberglass ceiling tiles. The discrete area sound-absorbing ceiling surface 209 may, for example, be a ceiling tile of a standard size that fits within a suspended ceiling grid that includes multiple such ceiling tiles, or may be a more free form shape with a monolithic appearance, e.g., an acoustical cloud, made from the same material. For example, the grid may include T-shaped beams and cross segments that form a rigid frame, into which the discrete area sound-absorbing ceiling surfaces 209, such as mineral fiber ceiling tiles, are fitted. The discrete area sound-absorbing ceiling surface 209 may, for example, be sized to fit within a standard ceiling grid of a size of one foot by one foot, two feet by two feet, or two feet by four feet. The discrete area sound-absorbing ceiling surface 209 may, for example, be a mineral fiber ceiling tile sold by Armstrong World Industries, Inc. of Lancaster, Pa., U.S.A., or USG Corporation of Chicago, Ill., U.S.A., although other mineral fiber ceiling tiles and other types of discrete area sound-absorbing ceiling surface may be used.

In accordance with an embodiment of the invention, the strength properties, such as the hardness, friability, sag and/or transverse strength, of the discrete area sound-absorbing ceiling surface may be measured and characterized according to the standards set forth in ASTM Standard C367/C367M, entitled “Standard Test Methods for Strength Properties of Prefabricated Architectural Acoustical Tile or Lay-In Ceiling Panels,” published by ASTM International of West Conshohocken, Pa., U.S.A., the entire disclosure of which is hereby incorporated herein by reference.

Further, in accordance with an embodiment of the invention, the acoustical ratings of the discrete area sound-absorbing ceiling surface may be measured and characterized according to the standards set forth in ASTM Standard E1264, entitled “Standard Classification for Acoustical Ceiling Products,” published by ASTM International of West Conshohocken, Pa., U.S.A., the entire disclosure of which is hereby incorporated herein by reference.

In addition, the discrete area sound-absorbing ceiling surface in accordance with an embodiment of the invention need not be in the shape of a tile; for example, the discrete area sound-absorbing ceiling surface can be an arch shape, a polygonal shape, an oval shape, a circle shape, or another shape. Such shapes may, for example, be made of mineral fiber and pre-cut into such shapes. In addition, the discrete area sound-absorbing ceiling surface may be at least a portion of a “cloud” array of ceiling surfaces. For example, a cloud array is often formed of multiple mineral fiber surfaces arranged in an array that is suspended above a floor area in a building, and, in accordance with an embodiment of the invention, may have a sound assembly taught herein attached to at least one surface in the cloud array. For example, a sound assembly taught herein may be used in a six by three mineral fiber cloud array, or another cloud array. The ceiling coupler, such as attachment plate 202 may be of a shape, and may be in a position on the ceiling tile 209, which optimizes the acoustical output as desired, for example for sound masking. The attachment plate 202 or other ceiling coupler may be attached to the ceiling tile 209 using any suitable long-lasting adhesive, such as a spray-on glue or a foam tape. For example, the attachment plate 202 or other ceiling coupler may have double sided foam tape on its bottom surface, such as 3M™ double-coated urethane or polyethylene foam tape sold by 3M Company of St. Paul, Minn., U.S.A.

In accordance with an embodiment of the invention, the vibration exciter 201 may comprise a voice coil, of a type discussed further below, or other types of vibration exciters discussed further below.

In one embodiment according to the invention, the vibration exciter 201 may be electrically coupled to receive a Direct Current (DC) electrical current in addition to the electrical sound signal. This may be useful in order to prevent the weight of the vibration exciter 201, for example when the vibration exciter 201 is a voice coil assembly, from reducing the possible amplitude of vibration because of a gravitationally induced offset, since the DC current will function to lift the magnet back to a neutral position that is in a direction away from the discrete area sound-absorbing ceiling surface 209, thereby counteracting the weight of the voice coil. Alternatively, or in addition, a mechanical support structure of the vibration exciter 201 may be strengthened.

With reference to the embodiment of FIG. 2A, the vibration exciter 201 may be electrically coupled to one or more sources of the electrical sound signal, such as a sound masking signal generator (not shown). The signal delivered to the vibration exciter 201 may be one or more channels of a sound masking signal, where different channels may be delivered to different nearby discrete area sound-absorbing ceiling surfaces 209 in an array of such ceiling surfaces, with each such ceiling surface 209 configured to operate as in FIG. 2A. Alternatively, a sound masking signal may have only one channel. Multiple discrete area sound-absorbing ceiling surfaces 209, or only a single discrete area sound-absorbing ceiling surface 209, may operate to perform sound masking for a predetermined area of a building comprising a sound masking zone below the one or more discrete area sound-absorbing ceiling surface 209. Multiple neighboring discrete area sound-absorbing ceiling surfaces used as loudspeaker assemblies may be interconnected in a daisy-chain fashion, similar to that taught in U.S. Pat. App. Pub. No. 2007/0133816, the entire teachings of which are hereby incorporated herein by reference in their entirety. In one embodiment, a sound masking signal generator includes a low pass filter network that has a sharp cutoff frequency just above the sound masking frequency band such that each sound masking assembly, such as each vibration exciter 201, electrically coupled to the masking signal generator receives a filtered electrical sound masking signal, in order to eliminate output at frequencies higher than the sound masking band of each ceiling tile 209, which may be more directional and hence more easily noticed by a listener.

By virtue of using such a sound assembly attached to the discrete area sound-absorbing ceiling surface 209, a system in accordance with an embodiment of the invention may provide the advantage of permitting the lowest frequency components of the sound signal to be lower than would ordinarily be the case with some cone loudspeakers. Further, the sound system may be entirely hidden from a viewer, by virtue of being concealed above the discrete area sound-absorbing ceiling surface 209, and may preclude the listener from locating the sound system. The system may also be more convenient and inexpensive to install than other tile mounted sound masking systems, since no modification of the ceiling is required. For example, the discrete area sound-absorbing ceiling surface 209 may be a pre-existing ceiling tile in an area of a building comprising a sound masking zone below the ceiling tile; and the attachment plate 202 or other ceiling coupler may be directly attached to a top surface of the ceiling tile, where the pre-existing ceiling tile is otherwise unmodified for sound masking. As another advantage, the sound assembly according to the invention may provide a slightly larger area of coverage per sound assembly than conventional cone loudspeakers, because the attached discrete area sound-absorbing ceiling surface (such as a mineral fiber ceiling tile) may radiate the produced acoustic sound signal over a larger area into the space below the ceiling surface compared to that possible with conventional systems. In addition, while not being bound by any theory, it appears that a mineral fiber ceiling tile, for example, performs well in producing a diffuse and incoherent masking sound, by virtue of exciting a variety of different modes of vibration of the mineral fiber ceiling tile.

FIG. 3 is a schematic side view diagram of a sound system including a sound assembly with an attachment piece that is a recessed ceiling coupler 302, in accordance with an embodiment of the invention. In this embodiment, rather than using an attachment plate 202 as in the embodiment of FIGS. 1A and 1B, a ceiling coupler 302 is recessed into a recess in the discrete area sound-absorbing ceiling surface 309. For example, a two-inch diameter, half-inch depth depression (or other size depression) may be made in the upper surface of a mineral fiber ceiling tile, in order to receive the recessed ceiling coupler 302. The ceiling coupler 302 may, for example, include one or more spring-loaded fittings 314 (for example, bayonet fittings) configured to penetrate (and, thus, attach to) the discrete area sound absorbing ceiling surface upon installation. The ceiling coupler 302 may have a portion that is configured to fit into a recess in the ceiling tile, while not necessarily being itself recessed into the ceiling tile. The vibration exciter 301 may be coupled, e.g., adhesively or mechanically, to the recessed ceiling coupler 302 to produce vibrations in the ceiling coupler 302 and thereby in the discrete area sound absorbing ceiling surface 309. Electrical cables (not shown in FIG. 3) may be connected to the vibration exciter 301.

FIG. 4 is a schematic side view diagram of a sound system including a sound assembly with an attachment piece that is an embedded ceiling coupler, in accordance with an embodiment of the invention. In this embodiment, an alternate ceiling coupler 402 is used, which is fully embedded within the discrete area sound absorbing ceiling surface 409. The vibration exciter 401 may or may not also be embedded within the discrete area sound absorbing ceiling surface 409, and is coupled to the recessed ceiling coupler 402, e.g., adhesively or mechanically, to produce vibrations in the ceiling coupler 402 and thereby in the discrete area sound absorbing ceiling surface 409. Electrical cables (not shown in FIG. 4) may be connected to the vibration exciter 401 and extend out of the discrete area sound absorbing ceiling surface 409.

A sound masking system in accordance with an embodiment of the invention may use a sound masking spectrum based on the principles of the spectrum described in L. L. Beranek, “Sound and Vibration Control,” McGraw-Hill, 1971, Page 593, the teachings of which reference are incorporated by reference in their entirety. The low end frequencies of the selected spectrum preferably comprise at least one of 50 Hz, 80 Hz and 100 Hz, most preferably 80 Hz. The high end frequencies are preferably less than 8 kHz and more preferably about 5300 Hz or less. It will be appreciated that other sound masking spectra may be used.

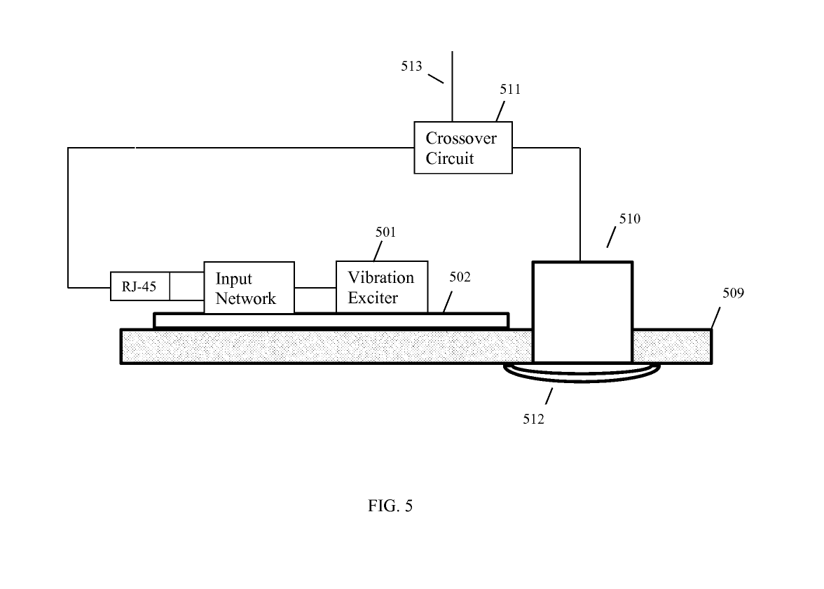

FIG. 5 is a schematic diagram of an alternative sound system in accordance with an embodiment of the invention, in which a crossover circuit 511 is used to employ a discrete area sound-absorbing ceiling surface 509 in conjunction with a cone loudspeaker assembly 510. In the embodiment of FIG. 5, a conventional cone loudspeaker assembly 510 that may be used for sound masking is inserted through the discrete area sound-absorbing ceiling surface 509, for example with acoustic sound masking signals being able to be emitted through grill 512. In addition, however, the discrete area sound-absorbing ceiling surface 509 itself is used as a loudspeaker, for example for sound masking, as in the embodiments of FIGS. 1A/1B, 2, 3 and 4. In operation, a crossover circuit 511 operates to deliver lower frequency components of the electrical sound signal to the vibration exciter 501, which is attached, via attachment plate 502 or another type of ceiling coupler, to the discrete area sound-absorbing ceiling surface 509, while higher frequency components of the electrical sound signal are delivered to the cone loudspeaker assembly 510. For example, frequency components of the electrical sound signal lower than a threshold frequency may be delivered to vibration exciter 501 to vibrate discrete area sound-absorbing ceiling surface 509 to emit lower frequency components of the acoustic sound signal; while frequency components of the electrical sound signal higher than the threshold frequency are delivered to cone loudspeaker assembly 510 to emit higher frequency components of the acoustic sound signal. The crossover circuit 511 may be coupled via input connection 513 to one or more sources of the electrical sound signal (not shown), which includes both the lower frequency components and the higher frequency components.

In the embodiment of FIG. 5, the cone loudspeaker assembly 510 may comprise a cone emitter having an effective aperture area that is less than or equal to the area of a circle having a diameter of between 1.25 inches and 3 inches; and may be of a type that is suitable to function as a direct field, low directivity index cone loudspeaker, such as the type taught in U.S. Pat. No. 7,194,094 B2 of Horrall et al., the teachings of which patent are incorporated by reference in their entirety.

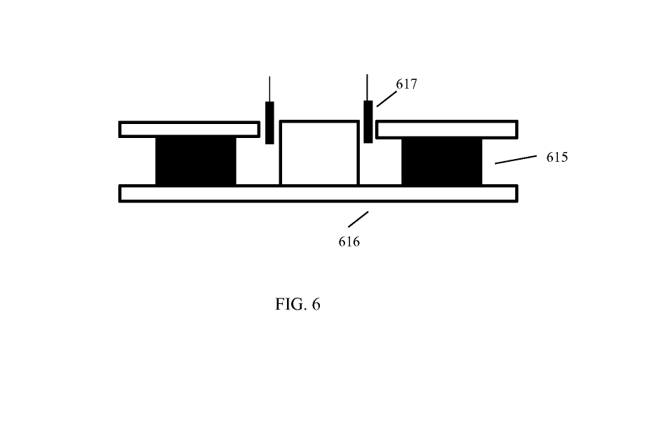

FIG. 6 is a schematic diagram of a voice coil that may be used as a vibration exciter in accordance with an embodiment of the invention. The voice coil includes permanent magnets 615, soft iron 616 and the coil 617. Those of skill in the art will appreciate that various types of voice coils may be used as a vibration exciter in accordance with an embodiment of the invention. For example, the vibration exciter may comprise a voice coil of a rating of less than or equal to a 5 pound force.

In addition, other types of vibration exciters may be used that are not voice coils. For example, the vibration exciter may comprise a piezoelectric element (such as a piezoelectric bender bar) or a single-ended electrostatic element. More than one exciter, and more than one different type of exciter, may be used in one assembly. The vibration exciter may be mounted directly to the ceiling coupler, for example by adhering a voice coil (or other vibration exciter) directly to the attachment plate (or other ceiling coupler), without an intervening support structure other than any small supports that are conventionally included to support a voice coil.

In accordance with an embodiment of the invention, a discrete area sound-absorbing ceiling surface 209 (see FIG. 2A) may be used without further assemblies attached on its lower surface, e.g., the surface on the inside of a sound masking zone; and with no sound components protruding through or below its bottom surface, for example facing into at least one sound masking zone. Alternatively, other structures may be positioned beneath the discrete area sound-absorbing ceiling surface 209, such as one or more reflectors. For example, one or more small reflectors may be positioned in front of, and a small distance below, the loudspeaker aperture of the cone loudspeaker assembly 510 (see FIG. 5), in order to scatter high frequency sounds to the sides of the cone loudspeaker assembly 510 to prevent the high frequency sounds from being axially projected by the assembly 510.

A sound system in accordance with an embodiment of the invention may be used to output other sounds, in addition to sound masking signals, such as for music and paging, using the vibrations of the same discrete area sound-absorbing ceiling surface 209 that is used for sound masking.

Further, a sound system in accordance with an embodiment of the invention may be used in conjunction with known features of sound masking systems generally, such as those taught in U.S. Pat. No. 7,194,094 B2 of Horrall et al., the teachings of which patent are incorporated by reference in their entirety.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A sound vibration excitation assembly, the assembly comprising:
a ceiling coupler configured to be coupled to a discrete area sound-absorbing ceiling surface comprising mineral fiber or fiberglass, the ceiling coupler configured to be coupled to a single contact area on the discrete area sound-absorbing ceiling surface; and
a vibration exciter configured to be electrically coupled to one or more sources of an electrical sound signal, the vibration exciter being coupled to the ceiling coupler to produce vibrations in the ceiling coupler in response to the electrical sound signal.

2. The sound assembly of claim 1, wherein the electrical sound signal comprises a sound masking signal.

3. The sound assembly of claim 1, wherein the electrical sound signal comprises at least one of a music signal and a paging signal.

4. The sound assembly of claim 1, wherein the ceiling coupler comprises an attachment plate.

5. The sound assembly of claim 4, wherein the attachment plate comprises a bottom surface configured to be attached face to face to a surface of the discrete area sound absorbing ceiling surface.

6. The sound assembly of claim 5, further comprising:
an adhesive layer on the bottom surface of the attachment plate; and
a removable backing paper overlaying a bottom surface of the adhesive layer.

7. The sound assembly of claim 4, wherein the attachment plate comprises a plate from the group consisting of: a continuously curved plate and a polygonal plate.

8. The sound assembly of claim 4, wherein the attachment plate comprises a triangular plate.

9. The sound assembly of claim 1, wherein the ceiling coupler comprises an attachment piece configured to be positioned in a recess in a top surface of the discrete area sound absorbing ceiling surface.

10. The sound assembly of claim 9, wherein the attachment piece comprises at least one spring-loaded fitting configured to penetrate the discrete area sound absorbing ceiling surface.

11. The sound assembly of claim 1, wherein the ceiling coupler comprises an attachment piece configured to be embedded inside the discrete area sound absorbing ceiling surface.

12. The sound assembly of claim 1, wherein the ceiling coupler comprises a plastic.

13. The sound assembly of claim 12, wherein the plastic comprises at least one of poly(methyl methacrylate) and polycarbonate.

14. The sound assembly of claim 1, wherein the ceiling coupler comprises a substantially larger minimum dimension than a maximum dimension of the vibration exciter.

15. The sound assembly of claim 1, wherein the vibration exciter comprises a voice coil.

16. The sound assembly of claim 1, wherein the vibration exciter comprises at least one of a piezoelectric element and a single-ended electrostatic element.

17. The sound assembly of claim 16, wherein the vibration exciter comprises a piezoelectric bender bar.

18. The sound assembly of claim 1, wherein the vibration exciter is mounted directly to the ceiling coupler.

19. The sound assembly of claim 1, wherein the discrete area sound-absorbing ceiling surface comprises a mineral fiber ceiling tile.

20. The sound assembly of claim 1, further comprising a quick connect/disconnect jack electrically coupled to the vibration exciter.

21. The sound assembly of claim 20, wherein the quick connect/disconnect jack corresponds to a TIA/EIA-IS-968-A Registered Jack 45 (RJ-45) connector.

22. The sound assembly of claim 1, wherein the vibration exciter is coupled to the ceiling coupler to produce vibrations in the discrete area sound-absorbing ceiling surface to thereby emit an acoustic sound masking signal in response to the electrical sound signal, wherein the acoustic sound masking signal has a corresponding sound masking spectrum, said sound masking spectrum having a low end frequency of at least about 80 Hz and a high end frequency of less than about 5300 Hz.

23. The sound assembly of claim 1, further comprising the one or more sources of the electrical sound signal, electrically coupled to the vibration exciter.

24. The sound assembly of claim 1, further comprising an input network electrically coupled to the vibration exciter.

25. The sound assembly of claim 1, wherein the vibration exciter is further electrically coupled to receive a Direct Current (DC) electrical current in addition to the electrical sound signal.

26. The sound assembly of claim 1, wherein the vibration exciter comprises a voice coil of a rating less than or equal to a 5 pound force.

27. The sound assembly of claim 1, further comprising a cone loudspeaker assembly and a crossover circuit electrically coupled to the cone loudspeaker assembly and to the vibration exciter, the crossover circuit configured:
(i) to operatively couple the one or more sources of the electrical sound signal to the vibration exciter to produce output of an acoustic sound masking signal from the discrete area sound-absorbing ceiling surface in a range of frequencies lower than a threshold frequency, and
(ii) to operatively couple the one or more sources of the electrical sound signal to the cone loudspeaker assembly to produce output of the acoustic sound masking signal from the cone loudspeaker assembly in a range of frequencies higher than the threshold frequency.
